(19) United States
(12) Patent Application Publication
(10) Pub. No.: US 2020/0036586 A1
(43) Pub. Date: Jan. 30, 2020

(54) DATA TRANSMISSION METHOD AND DEVICE

(71) Applicant: China Academy of Telecommunications Technology, Beijing (CN)

(72) Inventors: Xuejuan GAO, BEIJING (CN); Xueming PAN, BEIJING (CN); Fang-Chen CHENG, BEIJING (CN)

(21) Appl. No.: 16/335,686

(22) PCT Filed: Jun. 29, 2017
(86) PCT No.: PCT/CN2017/090886

§ 371 Date: Mar. 22, 2019

(30) Foreign Application Priority Data
Sep. 23, 2016 (CN) 201610849710.0

(51) Int. Cl. H04L 12/24; H04W 72/04; H04L 5/00; H04W 72/12

(52) U.S. Cl. CPC H04L 41/0806; H04W 72/1289; H04L 5/0055; H04W 72/0446

(57) ABSTRACT

Disclosed in the present application are a data transmission method and device, solving the problem of using a dynamic uplink-downlink resource division manner for data transmission in a new wireless communication system. The method comprises: a terminal determining the start position of a time unit of the terminal, and determining the division of an uplink region and a downlink region in the time unit; the terminal detecting a downlink control channel in the downlink region of the time unit; and according to the detection result, the terminal performing an uplink transmission in the uplink region corresponding to the downlink region. As a terminal uses a time unit specific to the terminal for transmission, time units of different terminals may have different start positions, and the number and lengths of the uplink regions and/or downlink regions included in the time units of different terminals may also be different. Thus, the invention can support flexible and variable resource division.

### CROSS-REFERENCE TO RELATED APPLICATIONS

This application claims the priority of Chinese Patent Application No. 201610849710.0, filed with the Chinese Patent Office on Sep. 23, 2016, and entitled “A method and device for transmitting data”, which is hereby incorporated by reference in its entirety.

### FIELD

The present invention relates to the field of communications, and particularly to a method and device for transmitting data.

### BACKGROUND

FIG. 1 illustrates the Frame Structure type 2 (FS2) defined for the Time Division Duplex (TDD) mode in the existing Long Term Evolution (LTE) system. There are different subframes or slots, over the same frequency, for uplink and downlink transmission. Each 10 ms radio frame includes two 5 ms half-frames, and each half-frame includes five subframes with the length of 1 ms. The subframes in the FS2 are categorized into downlink subframe, uplink subframes, and special subframes, and each special subframe includes a Downlink Pilot Time Slot (DwPTS), a Guard Period (GP), and an Uplink Pilot Time Slot (UpPTS). Each half-frame includes at least one downlink subframe, at least one uplink subframe, and at most one special subframe. Seven TDD uplink-downlink configurations as depicted in Table 1, and ten special subframe structures as depicted in Table 2 are defined for different downlink to uplink switching periodicities and uplink-downlink allocation proportions.

TABLE 1
Uplink-downlink configurations

| | Downlink- | | | | | | | | | | |
|---|---|---|---|---|---|---|---|---|---|---|---|
| Uplink- | to-Uplink | | | | | | | | | | |
| downlink | Switching | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

TABLE 2
Special subframe configurations (including DwPTS/GP/UpPTS lengths)

| | Normal cyclic prefix in the | | | Extended cyclic prefix in the | | |
|---|---|---|---|---|---|---|
| | downlink | | | downlink | | |
| Special | | UpPTS | | | UpPTS | |
| subframe | | Normal | Extended | | Normal | Extended |
| configuration | DwPTS | [symbol] | [symbol] | DwPTS | [symbol] | [symbol] |
| 0 | 6592 · Tₛ | (1 + X) · 2192 · Tₛ | (1 + X) · 2560 · Tₛ | 7680 · Tₛ | (1 + X) · 2192 · Tₛ | (1 + X) · 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | (2 + X) · 2192 · Tₛ | (2 + X) · 2560 · Tₛ |
| 5 | 6592 · Tₛ | (2 + X) · 2192 · Tₛ | (2 + X) · 2560 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

[symbol]

indicates data missing or illegible when filed

Where Ts is an interval of sampling time in the system, and X is a predefined or preconfigured value.

In the LTE system, uplink and downlink resources are allocated by defining the TDD frame structure above, so a cell can only be configured with one TDD frame structure, and since only the fixed division of the uplink and downlink resources is supported, where the division is notified via system information broadcasted in the cell, the fixed division of the uplink and downlink resources in the cell is shared among all the UEs in the cell.

Furthermore in the LTE system, a GP shall be arranged between an uplink resource and a downlink resource to thereby avoid interference between the uplink and the downlink in the same cell, and to switch from the downlink to the uplink. A GP only exists in a special subframe in each TDD uplink-downlink configuration, and the length of the GP is determined by a special subframe configuration corresponding to a division of the lengths of a downlink resource (a DwPTS component), an uplink resource (an UpPTS component), and a GP component in a special subframe. The special subframe configuration is also notified in a cell via system information broadcasted in the cell, so the fixed special subframe configuration in the cell is shared among all the UEs in the cell.

As there are a growing demand for mobile communication services, the International Telecommunication Union (ITU), the 3rd Generation Partnership Project (3GPP), and other organizations come to research a new wireless communication system (e.g., a 5G system). The new wireless communication system can support various coexisting types of services, e.g., an enhanced Mobile Broad Band (eMBB) service, an Ultra Reliable & Low Latency Communication (URLLC) service, a Massive Machine Type Communication (mMTC) service, etc., and the amount of traffic of the same service may also vary. When uplink and downlink traffic shares the same frequency resource in a Time Division Multiplexing (TDM) mode, in order to support the different types of services and demands for the amount of traffic, a flexible and varying division of resources shall be supported.

There has been absent so far a definite solution to transmitting data over dynamically allocated uplink and downlink resources in a new wireless communication system.

### SUMMARY

Embodiments of the invention provide a method and device for transmitting data so as to address transmission of data over dynamically allocated uplink and downlink resources in a new wireless communication system.

In a first aspect, an embodiment of the invention provides a method for transmitting data, the method including:

determining, by a UE, a start position of a time unit of the UE, and determining a division of uplink and downlink regions in the time unit;

detecting, by the UE, a downlink control channel in the downlink region of the time unit; and

performing, by the UE, a uplink transmission in an uplink region corresponding to the downlink region according to a detection result.

Optionally, determining, by the UE, the start position of the time unit of the UE includes:

receiving, by the UE, a first configuration signaling, and determining the start position of the time unit according to the first configuration signaling, wherein:

the first configuration signaling carries a time offset of the time unit relative to a preset reference time unit; or the first configuration signaling carries information about the start position of the time unit.

Optionally, determining, by the UE, the division of uplink and downlink regions in the time unit includes:

receiving, by the UE, a second configuration signaling, and determining the division of uplink and downlink regions in the time unit according to the second configuration signaling; or

determining, by the UE, an uplink region in the time unit according to uplink scheduling signaling; or

determining, by the UE, an uplink region carrying Acknowledgement (ACK)/Negative Acknowledgement (NACK) for downlink transmission according to a feedback position of the ACK/NACK;

wherein the second configuration signaling carries information about the length and the position of at least one of an uplink region, a downlink region, and a GP region in the time unit; or

the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or

the second configuration signaling carries information about a start position or the end position of one or more downlink regions in the time unit; or

the second configuration signaling carries information about a start position or the end position of one or more uplink regions in the time unit.

Optionally, performing, by the UE, the uplink transmission in the uplink region corresponding to the downlink region according to the detection result includes:

if a downlink control channel with an uplink DCI format is detected, transmitting, by the UE, an uplink shared channel in an uplink region corresponding to a downlink region including the downlink control channel; or

if a downlink control channel with a downlink DCI format, indicating a downlink SPS resource release is detected, feeding back, by the UE, ACK/NACK in an uplink region corresponding to a downlink region including the downlink control channel; or

if a downlink shared channel is detected, feeding back, by the UE, ACK/NACK in an uplink region corresponding to a downlink region including the downlink shared channel.

Optionally, if a downlink control channel with a downlink DCI format indicating a downlink SPS resource release is detected, the uplink region corresponding to the downlink region is: a predefined or pre-configured uplink region in the same time unit as the downlink region including the downlink control channel; or an uplink region determined according to an indicating field in the downlink control channel; or an uplink region spaced from the end of the downlink region including the downlink control channel by a preset length of time after the end of the downlink region;

or

if a downlink shared channel is detected, the uplink region corresponding to the downlink region is: a predefined or pre-configured uplink region in the same time unit as the downlink region including the downlink shared channel; or an uplink region determined according to an indicating field in scheduling signaling of the downlink shared channel; or an uplink region spaced from the end of the downlink region including the downlink shared channel by a preset length of time after the end of the downlink region;

or

if a downlink control channel with an uplink DCI format is detected, the uplink region corresponding to the downlink region is: a predefined or pre-configured uplink region in the same time unit as the downlink region including the downlink control channel; or a predefined or pre-configured uplink region in a time unit after the time unit including the downlink region including the downlink control channel; or an uplink region determined according to an indicating field in the downlink control channel.

Optionally, the time unit is one or more slots; or

the time unit is one or more subframes.

Optionally, the quantities of downlink regions in time units for transmitting different services are the same or different; and/or

the quantities of uplink regions in time units for transmitting different services are the same or different.

Optionally, if the time unit includes at least two downlink regions, lengths of the respective downlink regions are the same or different; and/or

if the time unit includes at least two uplink regions, lengths of the respective uplink regions are the same or different.

In a second aspect, an embodiment of the invention provides a method for transmitting data, the method including:

determining, by an eNB, a start position of a time unit of a UE, and determining a division of uplink and downlink regions in the time unit of the UE;

sending, by the eNB, downlink transmission to the UE in a downlink region in the time unit of the UE; and

receiving, by the eNB, uplink transmission of the UE in an uplink region corresponding to the downlink region including the downlink transmission.

Here, the time unit can be particularly as described in the first aspect, so a repeated description thereof will be omitted here; and the uplink region corresponding to the downlink region including the downlink transmission can be particularly as described in the first aspect, so a repeated description thereof will be omitted here.

Optionally, after the eNB determines the start position of the time unit of the UE, the method further includes:

notifying, by the eNB, the UE of the start position via first configuration signaling, wherein:

the first configuration signaling carries a time offset of the time unit of the UE relative to a preset reference time unit; or

the first configuration signaling carries information about the start position of the time unit of the UE.

Optionally, configuring by the eNB, UEs at edges of cells with a fixed start position of time unit via the first configuration signaling, and the fixed start position of time unit is a predefined or prescribed start position; or

configuring by the eNB, UEs at centers of cells with the same or different start positions of time units via the first configuration signaling.

Optionally, after the eNB determines the division of uplink and downlink regions in the time unit of the UE, the method further includes:

notifying, by the eNB, the UE of the division of uplink and downlink regions in the time unit of the UE via second configuration signaling, wherein:

the second configuration signaling carries information about a length and the position of at least one of an uplink region, a downlink region, and a GP region in the time unit; or

the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or

the second configuration signaling carries information about a start position or the end position of one or more downlink regions in the time unit of the UE; or

the second configuration signaling carries information about a start position or the end position of one or more uplink regions in the time unit of the UE.

Optionally, determining, by the eNB, the start position of the time unit of the UE, and determining the division of uplink and downlink regions in the time unit of the UE includes:

determining, by the eNB, a downlink region in a time unit of the UE as a GP region or a downlink region in a time unit of another UE; and/or

determining, by the eNB, an uplink region in a time unit of the UE as a GP region or an uplink region in a time unit of another UE.

Optionally, receiving, by the eNB, the uplink transmission of the UE in the uplink region corresponding to the downlink region including the downlink transmission includes:

if the downlink transmission is a downlink control channel with a downlink DCI format, indicating a downlink SPS resource release, receiving, by the eNB, ACK/NACK feedback for the downlink control channel in an uplink region corresponding to a downlink region including the downlink control channel; or

if the downlink transmission is a downlink shared channel, receiving, by the eNB, ACK/NACK feedback for the downlink shared channel in an uplink region corresponding to a downlink region including the downlink shared channel; or

if the downlink transmission is a downlink control channel with an uplink DCI format, receiving, by the eNB, an uplink shared channel corresponding to the downlink control channel in an uplink region corresponding to a downlink region including the downlink control channel.

In a third aspect, an embodiment of the invention provides a computer readable storage medium storing executable program codes configured to perform the method according to the first aspect.

In a fourth aspect, an embodiment of the invention provides a computer readable storage medium storing executable program codes configured to perform the method according to the second aspect.

In a fifth aspect, an embodiment of the invention provides a UE including:

a determining unit configured to determine a start position of a time unit of the UE, and to determine a division of uplink and downlink regions in the time unit;

a detecting unit configured to detect the downlink region in the time unit for a downlink control channel; and

a transmitting unit configured to perform a uplink transmission in an uplink region corresponding to the downlink region according to a detection result of the detecting unit.

Here, the time unit can be particularly as described in the first aspect, so a repeated description thereof will be omitted here; and the uplink region corresponding to the downlink region including the downlink transmission can be particularly as described in the first aspect, so a repeated description thereof will be omitted here.

Optionally, the determining unit is configured:

to receive first configuration signaling, and to determine the start position of the time unit according to the first configuration signaling, wherein:

the first configuration signaling carries a time offset of the time unit relative to a preset reference time unit; or the first configuration signaling carries information about the start position of the time unit.

Optionally the determining unit is configured:

to receive second configuration signaling, and to determine the division of uplink and downlink regions in the time unit according to the second configuration signaling; or

to determine an uplink region in the time unit according to uplink scheduling signaling; or

to determine an uplink region carrying ACK/NACK for downlink transmission according to a feedback position of the ACK/NACK;

wherein the second configuration signaling carries information about a length and the position of at least one of an uplink region, a downlink region, and a GP region in the time unit; or

the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or

the second configuration signaling carries information about a start position or the end position of one or more downlink regions in the time unit; or

the second configuration signaling carries information about a start position or the end position of one or more uplink regions in the time unit.

Optionally, the transmitting unit is configured:

if a downlink control channel with an uplink DCI format is detected, to transmit an uplink shared channel in an uplink region corresponding to a downlink region including the downlink control channel; or

if a downlink control channel with a downlink DCI format, to indicate a downlink SPS resource release is detected, to feed back ACK/NACK in an uplink region corresponding to a downlink region including the downlink control channel; or

if a downlink shared channel is detected, to feed back ACK/NACK in an uplink region corresponding to a downlink region including the downlink shared channel.

In a sixth aspect, an embodiment of the invention provides another UE including: a transceiver, and at least one processor connected with the transceiver, wherein:

the processor is configured to read and execute program in a memory:

to determine a start position of a time unit of the UE, and to determine a division of uplink and downlink regions in the time unit; to detect each downlink region in the time unit for a downlink control channel; and to perform a uplink transmission in an uplink region corresponding to the downlink region through the transceiver according to a detection result; and

the transceiver is configured to receive and transmit data under the control of the processor.

Optionally, the processor is configured to read and execute the program in the memory:

to receive a first configuration signaling through the transceiver, and to determine the start position of the time unit according to the first configuration signaling, wherein:

the first configuration signaling carries a time offset of the time unit relative to a preset reference time unit; or the first configuration signaling carries information about the start position of the time unit.

Optionally, the processor is configured to read and execute the program in the memory:

to receive second configuration signaling through the transceiver, and to determine the division of uplink and downlink regions in the time unit according to the second configuration signaling; or

to determine an uplink region in the time unit according to a uplink scheduling signaling; or

to determine an uplink region carrying ACK/NACK for a downlink transmission according to a feedback position of the ACK/NACK;

wherein the second configuration signaling carries information about a length and the position of at least one of an uplink region, a downlink region, and a GP region in the time unit; or

the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or

the second configuration signaling carries information about a start position or the end position of one or more downlink region in the time unit; or

the second configuration signaling carries information about a start position or the end position of one or more uplink regions in the time unit.

Optionally, the processor is configured to read and execute the program in the memory:

if a downlink control channel with an uplink DCI format is detected, to transmit an uplink shared channel in an uplink region corresponding to a downlink region including the downlink control channel through the transceiver; or

if a downlink control channel with a downlink DCI format, to indicate a downlink SPS resource release is detected, to feed back ACK/NACK in an uplink region corresponding to a downlink region including the downlink control channel through the transceiver; or

if a downlink shared channel is detected, to feed back ACK/NACK in an uplink region corresponding to a downlink region including the downlink shared channel through the transceiver.

In a seventh aspect, an embodiment of the invention provides an eNB including:

a determining unit configured to determine a start position of a time unit of a UE, and to determine a division of uplink and downlink regions in the time unit of the UE;

a downlink transmitting unit configured to send a downlink transmission to the UE in a downlink region in the time unit of the UE; and

a receiving unit configured to receive a uplink transmission of the UE in an uplink region corresponding to the downlink region including the downlink transmission.

Here, the time unit can be particularly as described in the first aspect, so a repeated description thereof will be omitted here; and the uplink region corresponding to the downlink region including the downlink transmission can be particularly as described in the first aspect, so a repeated description thereof will be omitted here.

Optionally, the determining unit is further configured:

to notify the UE of the start position via a first configuration signaling, wherein:

the first configuration signaling carries a time offset of the time unit of the UE relative to a preset reference time unit; or

the first configuration signaling carries information about the start position of the time unit of the UE.

Optionally, the determining unit is configured:

to configure UEs at edges of cells with a fixed start position of time unit via the first configuration signaling, and the fixed start position of time unit is a predefined or prescribed start position; or

to configure UEs at centers of cells with the same or different start positions of time units via the first configuration signaling.

Optionally, the determining unit is further configured:

to notify the UE of the division of uplink and downlink regions in the time unit of the UE via second configuration signaling, wherein:

the second configuration signaling carries information about a length and the position of at least one of an uplink region, a downlink region, and a GP region in the time unit; or

the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or

the second configuration signaling carries information about a start position or the end position of one or more downlink regions in the time unit; or

the second configuration signaling carries information about a start position or the end position of one or more uplink regions in the time unit.

Optionally, the determining unit is configured:

to determine a downlink region in a time unit of the UE as a GP region or a downlink region in a time unit of another UE; and/or

to determine an uplink region in a time unit of the UE as a GP region or an uplink region in a time unit of another UE.

Optionally, the receiving unit is configured:

if the downlink transmission is a downlink control channel with a downlink DCI format, to indicate a downlink SPS resource release, to receive ACK/NACK feedback for the downlink control channel in an uplink region corresponding to a downlink region including the downlink control channel; or

if the downlink transmission is a downlink shared channel, to receive ACK/NACK feedback for the downlink shared channel in an uplink region corresponding to a downlink region including the downlink shared channel; or

if the downlink transmission is a downlink control channel with an uplink DCI format, to receive an uplink shared channel corresponding to the downlink control channel in an uplink region corresponding to a downlink region including the downlink control channel.

In an eighth aspect, an embodiment of the invention provides another eNB including: a transceiver, and at least one processor connected with the transceiver, wherein:

the processor is configured to read and execute program in a memory:

to determine a start position of a time unit of a UE, and to determine a division of uplink and downlink regions in the time unit of the UE; to send downlink transmission to the UE through the transceiver in a downlink region in the time unit of the UE; and to receive uplink transmission of the UE through the transceiver in an uplink region corresponding to the downlink region including the downlink transmission; and

the transceiver is configured to receive and transmit data under the control of the processor.

Here, the time unit can be particularly as described in the first aspect, so a repeated description thereof will be omitted here; and the uplink region corresponding to the downlink region including the downlink transmission can be particularly as described in the first aspect, so a repeated description thereof will be omitted here.

Optionally, the processor is further configured to read and execute the program in the memory:

to notify the UE of the start position via first configuration signaling, wherein:

the first configuration signaling carries a time offset of the time unit of the UE relative to a preset reference time unit; or

the first configuration signaling carries information about the start position of the time unit of the UE.

Optionally, the processor is configured to read and execute the program in the memory:

to configure UEs at edges of cells with a fixed start position of time unit via the first configuration signaling, and the fixed start position of time unit is a predefined or prescribed start position; or

to configure UEs at centers of cells with the same or different start positions of time units via the first configuration signaling.

Optionally, the processor is further configured to read and execute the program in the memory:

to notify the UE of the division of uplink and downlink regions in the time unit of the UE via second configuration signaling, wherein:

the second configuration signaling carries information about a length and the position of at least one of an uplink region, a downlink region, and a GP region in the time unit; or

the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or

the second configuration signaling carries information about a start position or the end position of one or more downlink regions in the time unit of the UE; or

the second configuration signaling carries information about a start position or the end position of one or more uplink regions in the time unit of the UE.

Optionally, the processor is configured to read and execute the program in the memory:

to determine a downlink region in a time unit of the UE as a GP region or a downlink region in a time unit of another UE; and/or

to determine an uplink region in a time unit of the UE as a GP region or an uplink region in a time unit of another UE.

Optionally, the processor is configured to read and execute the program in the memory:

if the downlink transmission is a downlink control channel with a downlink DCI format, to indicate a downlink SPS resource release, to receive ACK/NACK feedback for the downlink control channel through the transceiver in an uplink region corresponding to a downlink region including the downlink control channel; or

if the downlink transmission is a downlink shared channel, to receive ACK/NACK feedback for the downlink shared channel through the transceiver in an uplink region corresponding to a downlink region including the downlink shared channel; or

if the downlink transmission is a downlink control channel with an uplink DCI format, to receive an uplink shared channel corresponding to the downlink control channel through the transceiver in an uplink region corresponding to a downlink region including the downlink control channel.

In the methods and devices according to the embodiments of the invention, the eNB configures each UE with a time unit specific to the UE so that each UE transmits in the time unit specific to the UE, there may be different start positions of the time units of the different UEs, and there may be also different numbers and lengths of uplink regions and/or downlink regions in the time units of the different UEs, so that a flexible and varying division of resources can be supported.

### BRIEF DESCRIPTION OF THE DRAWINGS

FIG. 1 is a schematic structural diagram of the FS2 in the LTE system in the prior art.

FIG. 2 is a schematic diagram of a method for transmitting data at the UE side according to an embodiment of the invention.

FIG. 3 is a schematic diagram of a method for transmitting data at the eNB side according to an embodiment of the invention.

FIG. 4A is a schematic diagram of a first division of respective regions in a time unit of a UE according to a first embodiment of the invention.

FIG. 4B is a schematic diagram of a second division of respective regions in a time unit of a UE according to the first embodiment of the invention.

FIG. 4C is a schematic diagram of a third division of respective regions in a time unit of a UE according to the first embodiment of the invention.

FIG. 4D is a schematic diagram of a fourth division of respective regions in a time unit of a UE according to the first embodiment of the invention.

FIG. 5 is a schematic diagram of a UE according to an embodiment of the invention.

FIG. 6 is a schematic diagram of another UE according to an embodiment of the invention.

FIG. 7 is a schematic diagram of an eNB according to an embodiment of the invention.

FIG. 8 is a schematic diagram of another eNB according to an embodiment of the invention.

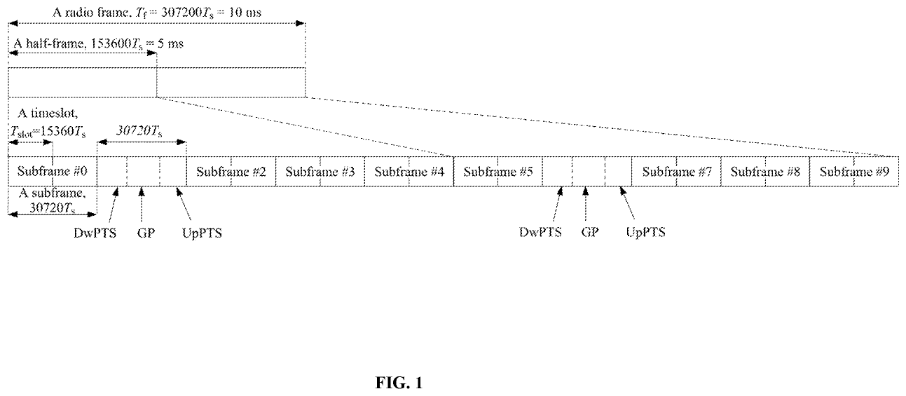

### DETAILED DESCRIPTION OF THE INVENTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments to be described below are only a part but not all of the embodiments of the invention. Based upon the embodiments here of the invention, all the other embodiments which can occur to those ordinarily skilled in the art without any inventive effort shall fall into the scope of the invention.

In the embodiments of the invention, each UE is configured with a specific time unit structure so that the UE can transmit data in its specific time unit. The time unit refers to a time unit on a time axis along which a UE transmits data, and start positions of time units of different UEs may be the same, or a part of the start positions may be the same, or each of the start positions may be different from any one of the other start positions. A time unit includes at least one uplink (UL) region for uplink transmission, and/or at least one downlink (DL) region for downlink transmission. Optionally a time unit further includes a GP region (which can also be referred to as a blank region).

Optionally, the sizes of respective downlink regions in a time unit may or may not be the same; and for example, the first downlink region in a time unit includes two symbols, and the second downlink region in the time unit includes three symbols.

Optionally, the sizes of respective uplink regions in a time unit may or may not be the same; and for example, the first uplink region in a time unit includes three symbols, and the second uplink region in the time unit includes four symbols.

Optionally, the symbol as mentioned in the invention may be an Orthogonal Frequency Division Multiplex (OFDM) symbol, or may be a Single Carrier Frequency Division Multiple Access (SC-FDMA), and of course, other multi-access symbols will not be precluded, and the same will apply hereinafter.

In the embodiments of the invention, a time unit is one or more slots; or a time unit is one or more subframes.

Optionally, a time unit is one or more consecutive slots; or a time unit is one or more consecutive subframes.

Optionally, the lengths of time units of different UEs are the same.

In the embodiments of the invention, for different services or transmission, the number of uplink regions and/or downlink regions in a time unit may or may not be the same; and for different services or transmission, the length of a time unit may or may not be the same. For different services or transmission, a correspondence relationship between DL and UL regions in a time unit may be defined uniformly or separately.

For example, for an eMBB service, a time unit includes one downlink region and one uplink region, and for example, the downlink region corresponds to the uplink region; and for a URLLC service, a time unit includes two downlink regions and two uplink regions, and for example, the first downlink region corresponds to the first uplink region, and the second downlink region corresponds to the second uplink region.

The embodiments of the invention will be described below in further details with reference to the drawings. It shall be appreciated that the embodiments described here are only intended to illustrate and explain the invention, but not to limit the invention thereto.

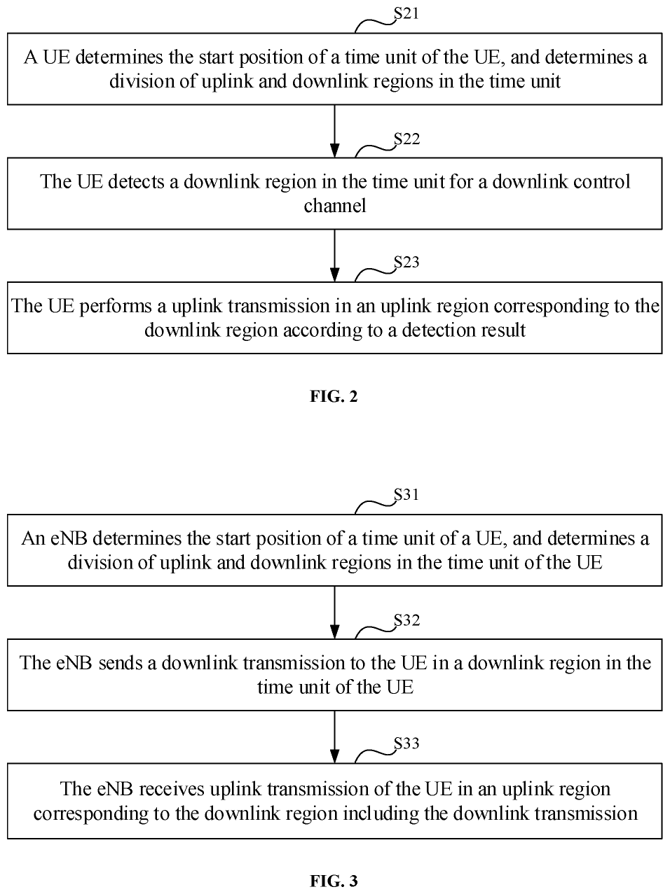

As illustrated in FIG. 2, an embodiment of the invention provides a method for transmitting data at the UE side, where the method includes the following steps.

In the step S21, a UE determines the start position of a time unit of the UE, and determines a division of uplink and downlink regions in the time unit.

In the step S22, the UE detects each downlink region in the time unit for a downlink control channel.

In the step S23, the UE performs uplink transmission in an uplink region corresponding to the downlink region according to a detection result.

In the embodiment of the invention, a UE determines the start position of a time unit of the UE, and determines a division of uplink and downlink regions in the time unit; detects each downlink region in the time unit for a downlink control channel; and performs uplink transmission in an uplink region corresponding to the downlink region according to a detection result. Since the UE transmits in the time unit specific to the UE, there may be different start positions of time units of different UEs, and also different numbers and lengths of uplink regions and/or downlink regions in the time units of the different UEs, thus supporting a flexible and varying division of resources.

In the embodiment of the invention, an uplink region in a time unit of a UE is a GP region or an uplink region in a time unit of another UE, thus improving the utilization ratio of system resources.

In the embodiment of the invention, a downlink region in a time unit of a UE is a GP region or a downlink region in a time unit of another UE, thus improving the utilization ratio of system resources.

Further to any one of the embodiments above, the UE determines the start position of the time unit of the UE in the step S21 as follows:

the UE receives first configuration signaling, and determines the start position of the time unit according to the first configuration signaling, where:

the first configuration signaling carries a time offset of the time unit relative to a preset reference time unit; or the first configuration signaling carries information about the start position of the time unit.

There are the following particular implementations.

1. If the first configuration signaling carries the information about the start position of the time unit, for example, the first configuration signaling carries the number of a symbol corresponding to the start position of the time unit of the UE, or the number of a mini-slot corresponding to the start position of the time unit of the UE, or the number of a slot corresponding to the start position of the time unit of the UE, or the number of a subframe corresponding to the start position of the time unit of the UE, then the UE may obtain the start position of the time unit of the UE directly from the first configuration signaling, where the symbol is the smallest time unit, the mini-slot is the smallest scheduling unit, and can include one or more symbols, the slot includes one or more min-slots, and the subframe includes one or more slots.

2. If the first configuration signaling carries a time offset of the time unit relative to the preset reference time unit, then the UE will determine the start position of the time unit of the UE according to the start position of the reference time unit, and the time offset carried in the first configuration signaling.

Optionally, the time offset carried in the first configuration signaling can be the number of symbols or mini-slots or slots or subframes of the offset of the start position of the time unit relative to the start position of the reference time unit.

Here, if the time offset is positive, then it will indicate that the start position of the time unit of the UE is arranged afterward relative to the start position of the reference time unit; if the time offset is negative, then it will indicate that the start position of the time unit of the UE is arranged ahead relative to the start position of the reference time unit; and if the time offset is zero, then it will indicate that the start position of the time unit of the UE is aligned with the start position of the reference time unit.

In the embodiment of the invention, the first configuration signaling is high-layer signaling, or configuration signaling transmitted in a downlink control channel, and can be broadcasted, or can be transmitted separately to each UE, where the downlink control channel can be transmitted in a UE-specific Search Space (USS), or can be transmitted in a Common Search Space (CSS). The first configuration signaling can be transmitted only once, or can be transmitted periodically.

Of course, the embodiment of the invention will not be limited to the start position of the time unit of the UE determined as described above, but the start position of the time unit of the UE may alternatively be determined otherwise, e.g., prescribed or predefined.

Further to any one of the embodiments above, the UE determines the division of uplink and downlink regions in the time unit in the step S21 in the following three possible implementations.

In a first implementation, the UE receives second configuration signaling, and determines the division of uplink and downlink regions in the time unit according to the second configuration signaling.

Optionally, the second configuration signaling is high-layer signaling, or configuration signaling transmitted in a downlink control channel, and can be broadcasted, or can be transmitted separately to each UE, where the downlink control channel can be transmitted in a USS, or can be transmitted in a CSS.

Optionally, the second configuration signaling can be transmitted only once, or can be transmitted at a preset periodicity. Furthermore different second configuration signaling may be transmitted in different periodicities. For example, the second configuration signaling carries information about the lengths and the positions of uplink regions in time units of a part of UEs, in a first preset periodicity; and the second configuration signaling carries information about the lengths and the positions of uplink regions in time units of the other UEs, in a second preset periodicity.

Optionally, the second configuration signaling and the first configuration signaling may be transmitted in the same configuration signaling, or may be transmitted differently.

In this implementation, there are the following four possible implementations of the second configuration signaling.

In an implementation a, the second configuration signaling carries information about the length and the position of at least one of an uplink region, a downlink region, and a GP region in the time unit of the UE.

Particularly, the information about the length and the position of at least one of the uplink region, the downlink region, and the GP region in the time unit of the UE is notified directly via the second configuration signaling.

In a possible implementation, the second configuration signaling carries information about the lengths and the positions of respective regions in the time unit of the UE. For example, if the time unit of the UE includes an uplink region and a downlink region, then the second configuration signaling will carry information about the lengths and the positions of the uplink region and the downlink region in the time unit of the UE, and if the time unit of the UE includes a plurality of uplink regions, and the lengths of the respective uplink regions are different, then the second configuration signaling will carry information about the lengths and the positions of the respective uplink regions in the time unit of the UE, e.g., the numbers of first symbols in the respective uplink regions, and the numbers of symbols in the respective uplink regions, or the numbers of first mini-slots in the respective uplink regions, and the numbers of mini-slots in the respective uplink regions, or the numbers of first slots in the respective uplink regions, and the numbers of slots in the respective uplink regions, or the numbers of first subframes in the respective uplink regions, and the numbers of subframes in the respective uplink regions; and the same will apply to downlink regions, so a repeated description thereof will be omitted here. The same will apply to the time unit of the UE including an uplink region, a downlink region, and a GP region, so a repeated description thereof will be omitted here.

In another possible implementation, the second configuration signaling carries information about the lengths and the positions of a part of regions in the time unit of the UE. Correspondingly the UE determines the lengths and the positions of the other regions according to the length and the start position of the time unit of the UE, and the information about the lengths and the positions of the part of the regions carried in the second configuration signaling.

For example, if the time unit of the UE includes an uplink region and a downlink region, then the second configuration signaling will carry the information about the length and the position of the uplink region in the time unit of the UE. Correspondingly the UE can determine the length and the position of the downlink region in the time unit according to the length and the start position of the time unit of the UE, and the length and the position of the uplink region in the time unit.

In another example, the time unit of the UE includes an uplink region, a downlink region, and a GP region, then the second configuration signaling will carry information about the lengths and the positions of the uplink region and the downlink region in the time unit of the UE, and correspondingly the UE can determine the length and the position of the GP region in the time unit according to the length and the start position of the time unit of the UE, and the lengths and the positions of the uplink region and the downlink region in the time unit; or the second configuration signaling will carry information about the lengths and the positions of the downlink region and the GP region in the time unit of the UE, and correspondingly the UE can determine the length and the position of the uplink region in the time unit according to the length and the start position of the time unit of the UE, and the lengths and the positions of the downlink region and the GP region in the time unit; etc.

In an implementation b, the second configuration signaling carries information representing an division pattern of an uplink region and/or a downlink region in the time unit, where the division pattern of an uplink region and/or a downlink region in the time unit is one of a plurality of preset division patterns of an uplink region and/or a downlink region in a time unit.

In this implementation, of the plurality of preset division patterns of an uplink region and/or a downlink region in a time unit, at least one of the start positions, the lengths, and the numbers of uplink regions in different division patterns are different, and/or at least one of the start positions, the lengths, and the numbers of downlink regions in different division patterns are different.

In this implementation, the second configuration signaling carries the information representing the division pattern of an uplink region and/or a downlink region in the time unit of the UE as the index of the division pattern of an uplink region and/or a downlink region. Correspondingly if the second configuration signaling carries the index of an division pattern of an uplink region in the time unit of the UE, then the UE will determine the corresponding division pattern of an uplink region from a preset set of division patterns of an uplink region in a time unit according to the index, and thus determine the length and/or the position of an uplink region in the time unit of the UE; if the second configuration signaling carries the index of an division pattern of a downlink region in the time unit of the UE, then the UE will determine the corresponding division pattern of a downlink region from a preset set of division patterns of a downlink region in a time unit according to the index, and thus determine the length and/or the position of a downlink region in the time unit of the UE; and if the second configuration signaling carries the index of an division pattern of an uplink region and a downlink region in the time unit of the UE, then the UE will determine the corresponding division pattern of an uplink region and a downlink region from a preset set of division patterns of an uplink region and a downlink region in a time unit according to the index, and thus determine the lengths and/or the positions of an uplink region and a downlink region in the time unit of the UE.

In an implementation c, the second configuration signaling carries information about the start position or the end position of a downlink region in the time unit of the UE.

In this implementation, the UE can obtain the start position or the end position of the downlink region in the time unit of the UE directly from the second configuration signaling, where if the second configuration signaling carries information about the start position of the downlink region in the time unit of the UE, then the UE can detect a downlink control channel starting with the start position, thus reducing the number of blind detections; and if the second configuration signaling carries information about the end position of the downlink region in the time unit of the UE, then the UE will detect all the regions before the end position blindly for a downlink control channel to determine the start position of the downlink control channel.

In this implementation, the UE can obtain the length of the downlink region in the time unit of the UE otherwise, e.g., through energy detection, or from other configuration signaling.

In an implementation d, the second configuration signaling carries information about the start position or the end position of an uplink region in the time unit.

In a second implementation, the UE determines an uplink region in the time unit according to uplink scheduling signaling.

For example, when the UE receives a downlink control channel with an uplink DCI format by detecting a downlink region in the time unit of the UE for a downlink control channel, the UE determines an uplink region in which an uplink shared channel scheduled by the downlink control channel is transmitted, according to predefined uplink scheduling timing, and/or a scheduling timing adjustment and/or a time position notified in the downlink control channel, as an uplink region of the UE in a time unit.

In a third implementation, the UE determines an uplink region carrying Acknowledgement (ACK)/Negative Acknowledgement (NACK) for downlink transmission according to a feedback position of the ACK/NACK.

By way of an example, the UE can determine a feedback position of ACK/NACK for downlink transmission according to a prescribed feedback delay, and/or a feedback delay adjustment and/or a feedback time position indicated in a downlink control channel corresponding to the downlink transmission for which the ACK/NACK is to be fed back, and for example, the feedback position of the ACK/NACK for the downlink transmission is n+T1, where n represents the number of a region including the downlink transmission, and T1 is a preset feedback delay; and for example, T1 is represented as k*a first Transmission Time Interval (TTI) length, or k*the first TTI length+T2, where the first TTI length can be a TTI length of uplink transmission, or of course, another TTI length thereof will not be precluded, e.g., a TTI length of downlink transmission; the value of k may be predefined, or notified in the downlink control channel; the value of T2 is determined as notified in the downlink control channel, represents an adjustment to a feedback delay, and can be represented directly as a particular value of a length of time, or can be represented as m*the first TTI length. The feedback position of the ACK/NACK of the downlink transmission can be determined as defined above, and a time position of the feedback position of the ACK/NACK can be determined as an uplink region.

Further to any one of the embodiments above, the UE performs uplink transmission in the uplink region corresponding to the downlink region according to the detection result in the step S13 in the following three possible implementations.

In a first implementation, if a downlink control channel with an uplink Downlink Control Information (DCI) format is detected, then the UE will transmit an uplink shared channel in an uplink region corresponding to a downlink region including the downlink control channel.

In this implementation, the uplink region corresponding to the downlink region is particularly:

a predefined or pre-configured uplink region in the same time unit as the downlink region including the downlink control channel; or

a predefined or pre-configured uplink region in a time unit after the time unit including the downlink region including the downlink control channel; or

an uplink region determined according to an indicating field in the downlink control channel.

In a second implementation, if a downlink control channel with a downlink DCI format, indicating a downlink Semi-Persistent Scheduling (SPS) resource release is detected, then the UE will feed back ACK/NACK in an uplink region corresponding to a downlink region including the downlink control channel.

In this implementation, the uplink region corresponding to the downlink region is particularly:

a predefined or pre-configured uplink region in the same time unit as the downlink region including the downlink control channel; or

an uplink region determined according to an indicating field in the downlink control channel; or

an uplink region spaced from the end of the downlink region including the downlink control channel by a preset length of time after the end of the downlink region.

In a third implementation, if a downlink shared channel is detected, then the UE will feed back ACK/NACK in an uplink region corresponding to a downlink region including the downlink shared channel.

In this implementation, the uplink region corresponding to the downlink region is particularly: a predefined or pre-configured uplink region in the same time unit as the downlink region including the downlink shared channel; or an uplink region determined according to an indicating field in scheduling signaling of the downlink shared channel; or an uplink region spaced from the end of the downlink region including the downlink shared channel by a preset length of time after the end of the downlink region.

Particularly, if the downlink shared channel is a dynamically scheduled physical downlink shared channel, then the scheduling signaling thereof will be a physical downlink control channel corresponding to the physical downlink shared channel; and if the downlink shared channel is an SPS physical downlink shared channel, then the scheduling signaling thereof will be a physical downlink control channel indicating the SPS resource to be activated.

Based upon the same inventive idea, as illustrated in FIG. 3, an embodiment of the invention provides a method for transmitting data at the eNB side, where a repeated description of the same components of the eNB side as the UE side will be omitted here, and the method includes the following steps.

In the step S31, an eNB determines the start position of a time unit of a UE, and determines a division of uplink and downlink regions in the time unit of the UE.

In the step S32, the eNB sends downlink transmission to the UE in a downlink region in the time unit of the UE.

In the step S33, the eNB receives uplink transmission of the UE in an uplink region corresponding to the downlink region including the downlink transmission.

Optionally, after the eNB determines the start position of the time unit of the UE, the method further includes:

the eNB notifies the UE of the start position via first configuration signaling, where:

the first configuration signaling carries a time offset of the time unit of the UE relative to a preset reference time unit; or

the first configuration signaling carries information about the start position of the time unit of the UE.

Optionally, the eNB configures UEs at the edges of cells with a fixed start position of time unit via the first configuration signaling, and the fixed start position of time unit is a predefined or prescribed start position which is the same for all the cells, thus avoiding mutual interference between UEs at the edges of the different cells; or

the eNB configures UEs at the centers of cells with the same or different start positions of time units via the first configuration signaling.

In a preferable implementation, the eNB configures the UEs at the centers of the cells with different start positions of time units via the first configuration signaling.

Further to any one of the embodiments above, after the eNB determines the division of uplink and downlink regions in the time unit of the UE, the method further includes:

the eNB notifies the UE of the division of uplink and downlink regions in the time unit of the UE via second configuration signaling, where:

the second configuration signaling carries information about the length and the position of at least one of an uplink region, a downlink region, or a GP region in the time unit; or the second configuration signaling carries information representing an division pattern of an uplink region and/or a downlink region in the time unit, where the division pattern of an uplink region and/or a downlink region in the time unit is one of a plurality of preset division patterns of an uplink region and/or a downlink region in a time unit; or

the second configuration signaling carries information about the start position or the end position of a downlink region in the time unit of the UE; or

the second configuration signaling carries information about the start position or the end position of an uplink region in the time unit of the UE.

Further to any one of the embodiments above, the eNB determines the start position of the time unit of the UE, and determines the division of uplink and downlink regions in the time unit of the UE particularly as follows:

The eNB determines a downlink region in a time unit of the UE as a GP region or a downlink region in a time unit of another UE; and/or

The eNB determines an uplink region in a time unit of the UE as a GP region or an uplink region in a time unit of another UE.

In a preferable implementation, the eNB determines a downlink region in a time unit of the UE as a GP region or a downlink region in a time unit of another UE, thus improving the utilization ratio of system resources;

and/or

the eNB determines an uplink region in a time unit of the UE as a GP region or an uplink region in a time unit of another UE, thus improving the utilization ratio of system resources.

In the embodiment of the invention, optionally the eNB configures start positions of time units of different UEs, and divisions of uplink and downlink regions in the time units separately, the numbers and/or the lengths of downlink regions and uplink regions in one time units of the different UEs may or may not be the same.

By way of an example, the eNB can pre-group the UEs into A groups, and there may be the same start position of, and division of uplink and downlink regions in, time units of UEs in each group; or there may be different start positions of time units of UEs in different groups; and divisions of uplink and downlink regions in time units of UEs in different groups may be configured separately, and may or may not be the same.

Further to any one of the embodiments above, in the step S33 the eNB receives the uplink transmission of the UE in the uplink region corresponding to the downlink region including the downlink transmission as follows:

if the downlink transmission is a downlink control channel with a downlink DCI format, indicating a downlink SPS resource release, then the eNB will receive ACK/NACK feedback for the downlink control channel in an uplink region corresponding to a downlink region including the downlink control channel; or

if the downlink transmission is a downlink shared channel, then the eNB will receive ACK/NACK feedback for the downlink shared channel in an uplink region corresponding to a downlink region including the downlink shared channel; or

if the downlink transmission is a downlink control channel with an uplink DCI format, then the eNB will receive an uplink shared channel corresponding to the downlink control channel in an uplink region corresponding to a downlink region including the downlink control channel.

Here, if the downlink transmission is a downlink control channel with a downlink DCI format, indicating a downlink SPS resource release, then the uplink region corresponding to the downlink region including the downlink transmission will be: a predefined or pre-configured uplink region in the same time unit as the downlink region including the downlink control channel; or an uplink region indicated in an indicating field in the downlink control channel; or an uplink region spaced from the end of the downlink region including the downlink control channel by a preset length of time after the end of the downlink region;

or

if the downlink transmission is a downlink shared channel, then the uplink region corresponding to the downlink region including the downlink transmission will be: a predefined or pre-configured uplink region in the same time unit as the downlink region including the downlink shared channel; or an uplink region indicated in an indicating field in scheduling signaling of the downlink shared channel; or an uplink region spaced from the end of the downlink region including the downlink shared channel by a preset length of time after the end of the downlink region;

or

if the downlink transmission is a downlink control channel in an uplink DCI format, then the uplink region corresponding to the downlink region including the downlink transmission will be: a predefined or pre-configured uplink region in the same time unit as the downlink region including the downlink control channel; or a predefined or pre-configured uplink region in a time unit after the time unit including the downlink region including the downlink control channel; or an uplink region indicated in an indicating field in the downlink control channel.

A method for transmitting data according to an embodiment of the invention will be described below in details in connection with a particular embodiment thereof.

In a first embodiment, for example, a time unit is a slot, where a slit includes seven OFDM symbols, and a subframe includes two slots. Of course, alternatively a time unit with another length can be defined in the embodiment of the invention similarly thereto, so a repeated description thereof will be omitted here.

Operations at the eNB side:

1) An eNB determines the start position of a time unit of a UE 1 as the start position of a reference time unit, determines the start position of a time unit of a UE 2 to be offset ahead relative to the start position of the time unit of the UE 1 by A OFDM symbols;

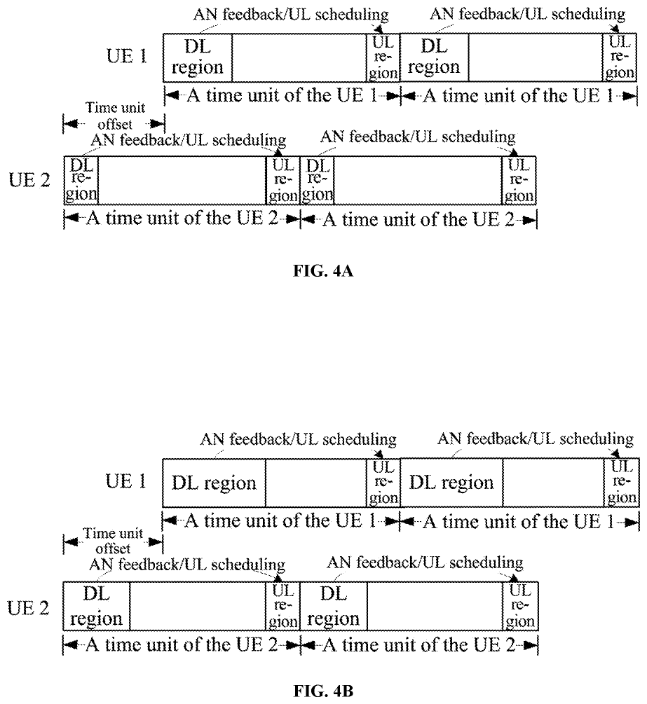

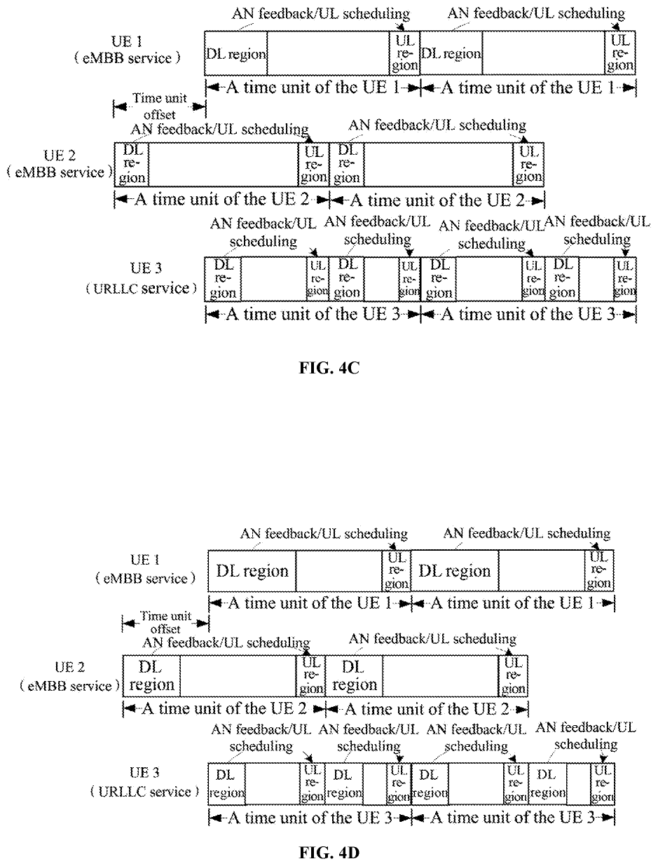

2) The eNB decides to divide a time unit of the UE1 into one DL region and one UL region, and there is a GP region (which can also be referred to as a blank region) between the DL region and the UL region that is a reserved region determined to satisfy a Timing Advance (TA) demand in the UL, a switching period of time from the DL to the UL, etc., possibly taking into account interference between adjacent cells, and other factors; and alike the eNB also decides to divide a time unit of the UE2 into one DL region and one UL region, where since the start position is offset, the DL region and the UL region of the UE1 overlap in time with the GP region of the UE2, and the DL and UL regions of the UE2 overlap in time with the GP region of the UE1, so that the eNB side can schedule data to be transmitted in any one period of time, thus improving the utilization ratio of system resources while avoiding interference between the uplink and the downlink, as illustrated in FIG. 4A. Of course, if no TA or switching period of time or anti-interference is required, then a GP region may alternatively be arranged only as needed for a processing delay, as illustrated in FIG. 4B. At this time, the time unit is offset so that a downlink region of the UE 1 in a time unit overlaps in time with a downlink region or a GP region of the UE 2, and an uplink region of the UE 1 in a time unit overlaps in time with an uplink region or a GP region of the UE 2; and the same will apply to the UE 2, so that a plurality of UEs can operate concurrently without any interference between the uplink and the downlink of the UEs.

In this embodiment, a correspondence relationship between a DL region of a UE in a time unit, and a UL region of the UE in the time unit can be predefined or pre-configured directly, and for the UE 1 and the UE 2, for example, a DL region in a time unit is predefined or pre-configured to schedule uplink transmission in an UL region in the time unit, where uplink transmission in the UL region may occupy only a part of OFDM or SC-FDMA symbols or a part of mini-slots in the UL region, so a plurality of uplink shared channels of the same or different UEs can be transmitted in a UL region in a TDM mode, or uplink transmission in the UL region may occupy the length of the entire UL region.

ACK/NACK for downlink transmission in a DL region in a time unit is fed back in a UL region in the time unit, where downlink transmission in the DL region may occupy only a part of OFDM symbols or a part of mini-slots in the DL region, so a plurality of downlink transmission instances of the same or different UEs can be transmitted in a DL region in a TDM mode, or downlink transmission in the DL region may occupy the length of the entire DL region; and an uplink channel carrying ACK/NACK feedback information for downlink transmission may occupy only a part of OFDM or SC-OFDM symbols or a part of mini-slots in the UL region, so a plurality of uplink channels, carrying ACK/NACK, of the same or different UEs can be transmitted in a UL region in a TDM mode, or the uplink channel may occupy the length of the entire UL region, as illustrated in FIG. 4A and FIG. 4B.

In this embodiment, the eNB to schedule the UE 1 transmits a downlink control channel to the UE 1 in a downlink control channel search space in a DL region in a time unit of the UE 1 to schedule the UE 1 to receive a downlink shared channel in the DL region, and/or to transmit an uplink shared channel in a UL region in the time unit of the UE 1; and the eNB to schedule the UE 2 transmits a downlink control channel to the UE 2 in a downlink control channel search space in a DL region in a time unit of the UE 2 to schedule the UE 2 to receive a downlink shared channel in the DL region, and/or to transmit an uplink shared channel in a UL region in the time unit of the UE 2.

Correspondingly the UE 1 and the UE 2 determine the start position of a time unit thereof, and determine a division of DL and UL regions in the time unit, respectively according to configuration information, and detect a DL region in a time unit blindly for a downlink control channel. When a downlink control channel thereof in a downlink DCI format is detected, they receive a corresponding downlink shared channel in the DL region, generate ACK/NACK feedback information (i.e., “AN” feedback) for the downlink shared channel, and make ACK/NACK feedback in a UL region corresponding to the DL region, that is, the UE 1 makes ACK/NACK feedback in a UL region in the time unit of the UE 1, and the UE 2 makes ACK/NACK feedback in a UL region in the time unit of the UE 2; and when a downlink control channel thereof in an uplink DCI format is detected, they transmit a corresponding uplink shared channel in a UL region corresponding to the DL region, that is, the UE 1 transmits a corresponding uplink shared channel in a UL region in the time unit of the UE 1, and the UE 2 transmits a corresponding uplink shared channel in a UL region in the time unit of the UE 2.

In this embodiment, if there is data transmission of different types of services, e.g., an eMBB service of the UE 1 and the UE 2, and a URLLC service of a UE 3, then different time unit patterns may be defined for the UEs with the different types of services, where for the UE with the URLLC service, more DL regions and UL regions than the eMBB service can be defined in a time unit, and for example, two DL regions and two UL regions are defined, where the first DL region corresponds to the first UL region, and the second DL region corresponds to the second UL region, as illustrated in FIG. 4C and FIG. 4D; and at this time, a time unit of the UE 3 may be aligned with that of the UE 1, a DL region of the UE 3 in a time unit overlaps in time with a DL region or a GP region of another UE, and a UL region of the UE 3 in a time unit overlaps in time with a UL region or a GP region of another UE, so that a plurality of UEs can operate concurrently without any interference between the uplink and the downlink of the UEs. Processing thereof will be similar to that as described above, so a repeated description thereof will be omitted here.

In this embodiment, for the eMBB service, one DL region and one UL region are defined in a time unit as described above only by way of an example, but of course, more than one DL region and more than one UL region can alternatively be defined in a time unit; and if a plurality of DL regions, and a plurality of UL regions are defined in a time unit, then a correspondence relationship between the plurality of DL regions, and the plurality of UL regions will be predefined or pre-configured; and for example, two DL regions and two UL regions are defined in a time unit, so feedback and scheduling correspondence relationships similar to those of the URLLC service in FIG. 4D may be defined.

The processing flows of the methods above can be performed in software program, the software program can be stored in a storage medium, and when the stored software program is invoked, it can perform the steps in the methods above.

Based upon the same inventive idea, an embodiment of the invention further provides a UE, and since the UE addresses the problem under a similar principle to the method as illustrated in FIG. 2, reference can be made to the implementation of the method for an implementation of the UE, and a repeated description thereof will be omitted here.

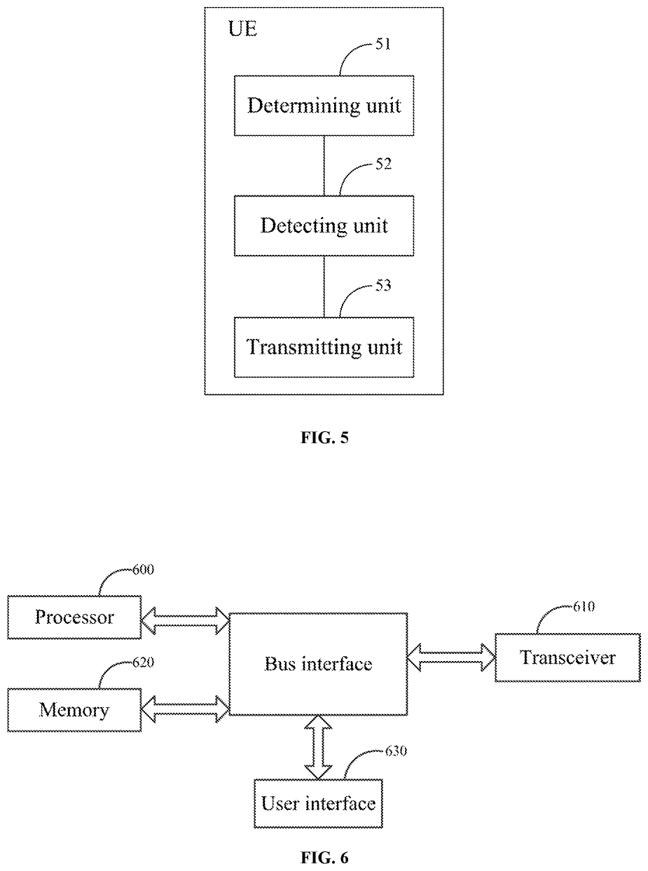

FIG. 5 illustrates a UE according to an embodiment of the invention, where the UE includes:

a determining unit 51 is configured to determine the start position of a time unit of the UE, and to determine a division of uplink and downlink regions in the time unit;

a detecting unit 52 is configured to detect each downlink region in the time unit for a downlink control channel; and

a transmitting unit 53 is configured to perform uplink transmission in an uplink region corresponding to the downlink region according to a detection result of the detecting unit.

Optionally, the determining unit 51 is configured:

to receive first configuration signaling, and to determine the start position of the time unit according to the first configuration signaling, where:

the first configuration signaling carries a time offset of the time unit relative to a preset reference time unit; or the first configuration signaling carries information about the start position of the time unit.

Optionally, the determining unit 51 is configured:

to receive second configuration signaling, and to determine the division of uplink and downlink regions in the time unit according to the second configuration signaling; or

to determine an uplink region in the time unit according to uplink scheduling signaling;

or

to determine an uplink region carrying ACK/NACK for downlink transmission according to a feedback position of the ACK/NACK;

where the second configuration signaling carries information about the length and the position of at least one of an uplink region, a downlink region, and a GP region in the time unit; or

the second configuration signaling carries information representing an division pattern of an uplink region and/or a downlink region in the time unit, where the division pattern of an uplink region and/or a downlink region in the time unit is one of a plurality of preset division patterns of an uplink region and/or a downlink region in a time unit; or

the second configuration signaling carries information about the start position or the end position of a downlink region in the time unit; or

the second configuration signaling carries information about the start position or the end position of an uplink region in the time unit.

Optionally, the transmitting unit 53 is configured:

if a downlink control channel with an uplink DCI format is detected, to transmit an uplink shared channel in an uplink region corresponding to a downlink region including the downlink control channel; or

if a downlink control channel with a downlink DCI format, indicating a downlink SPS resource release is detected, to feed back ACK/NACK in an uplink region corresponding to a downlink region including the downlink control channel; or

if a downlink shared channel is detected, to feed back ACK/NACK in an uplink region corresponding to a downlink region including the downlink shared channel.

Here, if a downlink control channel with a downlink DCI format indicating a downlink SPS resource release is detected, then the uplink region corresponding to the downlink region will be: a predefined or pre-configured uplink region in the same time unit as the downlink region including the downlink control channel; or an uplink region determined according to an indicating field in the downlink control channel; or an uplink region spaced from the end of the downlink region including the downlink control channel by a preset length of time after the end of the downlink region;

or

if a downlink shared channel is detected, then the uplink region corresponding to the downlink region will be: a predefined or pre-configured uplink region in the same time unit as the downlink region including the downlink shared channel; or an uplink region determined according to an indicating field in scheduling signaling of the downlink shared channel; or an uplink region spaced from the end of the downlink region including the downlink shared channel by a preset length of time after the end of the downlink region;

or

if a downlink control channel with an uplink DCI format is detected, then the uplink region corresponding to the downlink region will be: a predefined or pre-configured uplink region in the same time unit as the downlink region including the downlink control channel; or a predefined or pre-configured uplink region in a time unit after the time unit including the downlink region including the downlink control channel; or an uplink region determined according to an indicating field in the downlink control channel.

FIG. 6 illustrates another UE according to an embodiment of the invention, where the UE includes: a transceiver 610, and at least one processor 600 connected with the transceiver, where:

the processor 600 is configured to read and execute program in a memory 620:

to determine the start position of a time unit of the UE, and to determine a division of uplink and downlink regions in the time unit; to detect each downlink region in the time unit for a downlink control channel; and to perform uplink transmission in an uplink region corresponding to the downlink region through the transceiver 610 according to a detection result;

and

the transceiver 610 is configured to receive and transmit data under the control of the processor 600.

Here, in FIG. 6, the bus architecture can include any number of interconnecting buses and bridges to particularly link together various circuits including one or more processors represented by the processor 600, and one or more memories represented by the memory 620. The bus architecture can further link together various other circuits, e.g., a peripheral device, a manostat, a power management circuit, etc., all of which are well known in the art, so a further description thereof will be omitted in this context. The bus interface serves as an interface. The transceiver 610 can be an element, or can be a number of elements, e.g., a number of transmitters and receivers, which are units for communication with various other devices over a transmission medium. For different user equipments, the user interface 630 can also be an interface via which devices are connected internally and externally as needed, and the connected devices include but will not be limited to a keypad, a monitor, a speaker, a microphone, a joystick, etc. The processor 600 is responsible for managing the bus architecture and performing normal processes, and can further provide various functions of timing, a peripheral interface, voltage regulation, power source management, and other control functions, and the memory 620 can store data for use by the processor 600 in performing the operations.

Optionally, the processor 600 can be a Central Processing Unit (CPU), an Application-Specific Integrated Circuit (ASIC), a Field-Programmable Gate Array (FPGA), or a Complex Programmable Logic Device (CPLD).

Optionally, the processor 600 is configured to read and execute the program in the memory 620:

to receive first configuration signaling through the transceiver 610, and to determine the start position of the time unit according to the first configuration signaling, where:

the first configuration signaling carries a time offset of the time unit relative to a preset reference time unit; or the first configuration signaling carries information about the start position of the time unit.

Optionally, the processor 600 is configured to read and execute the program in the memory 620:

to receive second configuration signaling through the transceiver 610, and to determine the division of uplink and downlink regions in the time unit according to the second configuration signaling; or

to determine an uplink region in the time unit according to uplink scheduling signaling; or

to determine an uplink region carrying ACK/NACK for downlink transmission according to a feedback position of the ACK/NACK;

where the second configuration signaling carries information about the length and the position of at least one of an uplink region, a downlink region, and a GP region in the time unit; or

the second configuration signaling carries information representing an division pattern of an uplink region and/or a downlink region in the time unit, where the division pattern of an uplink region and/or a downlink region in the time unit is one of a plurality of preset division patterns of an uplink region and/or a downlink region in a time unit; or

the second configuration signaling carries information about the start position or the end position of a downlink region in the time unit; or

the second configuration signaling carries information about the start position or the end position of an uplink region in the time unit.

Optionally, the processor 600 is configured to read and execute the program in the memory 620:

if a downlink control channel with an uplink DCI format is detected, to transmit an uplink shared channel in an uplink region corresponding to a downlink region including the downlink control channel through the transceiver 610; or

if a downlink control channel with a downlink DCI format, indicating a downlink SPS resource release is detected, to feed back ACK/NACK in an uplink region corresponding to a downlink region including the downlink control channel through the transceiver 610; or

if a downlink shared channel is detected, to feed back ACK/NACK in an uplink region corresponding to a downlink region including the downlink shared channel through the transceiver 610;

where if a downlink control channel with a downlink DCI format indicating a downlink SPS resource release is detected, then the uplink region corresponding to the downlink region will be: a predefined or pre-configured uplink region in the same time unit as the downlink region including the downlink control channel; or an uplink region determined according to an indicating field in the downlink control channel; or an uplink region spaced from the end of the downlink region including the downlink control channel by a preset length of time after the end of the downlink region;

or

if a downlink shared channel is detected, then the uplink region corresponding to the downlink region will be: a predefined or pre-configured uplink region in the same time unit as the downlink region including the downlink shared channel; or an uplink region determined according to an indicating field in scheduling signaling of the downlink shared channel; or an uplink region spaced from the end of the downlink region including the downlink shared channel by a preset length of time after the end of the downlink region;

or

if a downlink control channel with an uplink DCI format is detected, then the uplink region corresponding to the downlink region will be: a predefined or pre-configured uplink region in the same time unit as the downlink region including the downlink control channel; or a predefined or pre-configured uplink region in a time unit after the time unit including the downlink region including the downlink control channel; or an uplink region determined according to an indicating field in the downlink control channel.

Based upon the same inventive idea, an embodiment of the invention further provides an eNB, and since the eNB addresses the problem under a similar principle to the method as illustrated in FIG. 3, reference can be made to the implementation of the method for an implementation of the eNB, and a repeated description thereof will be omitted here.

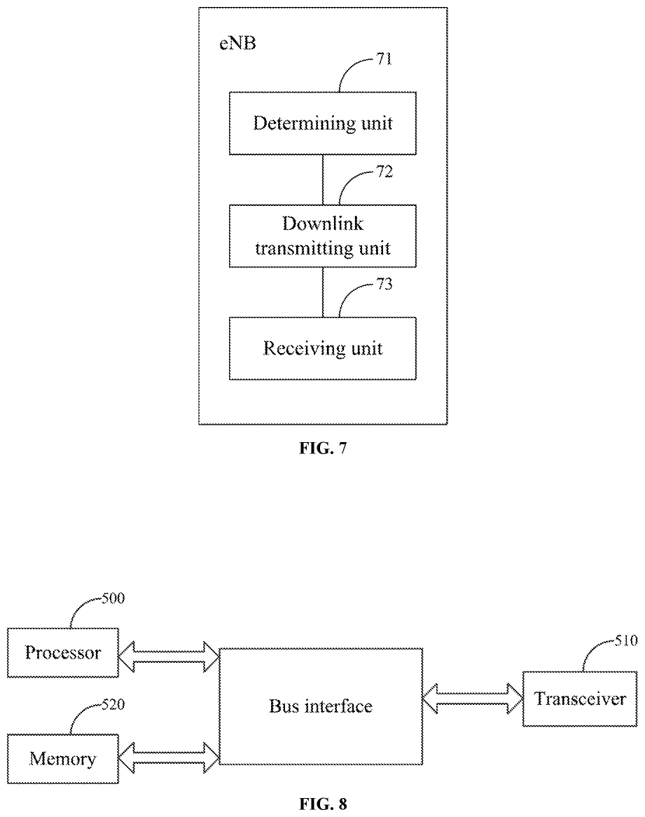

FIG. 7 illustrates an eNB according to an embodiment of the invention, where the eNB includes:

a determining unit 71 is configured to determine the start position of a time unit of a UE, and to determine a division of uplink and downlink regions in the time unit of the UE;

a downlink transmitting unit 72 is configured to send downlink transmission to the UE in a downlink region in the time unit of the UE; and

a receiving unit 73 is configured to receive uplink transmission of the UE in an uplink region corresponding to the downlink region including the downlink transmission.

Optionally, the determining unit 71 is further configured:

to notify the UE of the start position via first configuration signaling, where:

the first configuration signaling carries a time offset of the time unit of the UE relative to a preset reference time unit; or

the first configuration signaling carries information about the start position of the time unit of the UE.

Optionally, UEs at the edges of cells are configured with a fixed start position of time unit via the first configuration signaling, and the fixed start position of time unit is a predefined or prescribed start position; or

UEs at the centers of cells are configured with the same or different start positions of time units via the first configuration signaling.

Optionally, the determining unit 71 is further configured:

to notify the UE of the division of uplink and downlink regions in the time unit of the UE via second configuration signaling, where:

the second configuration signaling carries information about the length and the position of at least one of an uplink region, a downlink region, and a GP region in the time unit; or

the second configuration signaling carries information representing an division pattern of an uplink region and/or a downlink region in the time unit, where the division pattern of an uplink region and/or a downlink region in the time unit is one of a plurality of preset division patterns of an uplink region and/or a downlink region in a time unit; or

the second configuration signaling carries information about the start position or the end position of a downlink region in the time unit of the UE; or

the second configuration signaling carries information about the start position or the end position of an uplink region in the time unit of the UE.

Optionally, the determining unit 71 is configured:

to determine a downlink region in a time unit of the UE as a GP region or a downlink region in a time unit of another UE; and/or

to determine an uplink region in a time unit of the UE as a GP region or an uplink region in a time unit of another UE.

Optionally, the receiving unit 73 is configured:

if the downlink transmission is a downlink control channel with a downlink DCI format, indicating a downlink SPS resource release, to receive ACK/NACK feedback for the downlink control channel in an uplink region corresponding to a downlink region including the downlink control channel; or

if the downlink transmission is a downlink shared channel, to receive ACK/NACK feedback for the downlink shared channel in an uplink region corresponding to a downlink region including the downlink shared channel; or

if the downlink transmission is a downlink control channel with an uplink DCI format, to receive an uplink shared channel corresponding to the downlink control channel in an uplink region corresponding to a downlink region including the downlink control channel.

Here, if the downlink transmission is a downlink control channel with a downlink DCI format, indicating a downlink SPS resource release, then the uplink region corresponding to the downlink region including the downlink transmission will be: a predefined or pre-configured uplink region in the same time unit as the downlink region including the downlink control channel; or an uplink region indicated in an indicating field in the downlink control channel; or an uplink region spaced from the end of the downlink region including the downlink control channel by a preset length of time after the end of the downlink region;

or

if the downlink transmission is a downlink shared channel, then the uplink region corresponding to the downlink region including the downlink transmission will be: a predefined or pre-configured uplink region in the same time unit as the downlink region including the downlink shared channel; or an uplink region indicated in an indicating field in scheduling signaling of the downlink shared channel; or an uplink region spaced from the end of the downlink region including the downlink shared channel by a preset length of time after the end of the downlink region;

or

if the downlink transmission is a downlink control channel with an uplink DCI format, then the uplink region corresponding to the downlink region including the downlink transmission will be: a predefined or pre-configured uplink region in the same time unit as the downlink region including the downlink control channel; or a predefined or pre-configured uplink region in a time unit after the time unit including the downlink region including the downlink control channel; or an uplink region indicated in an indicating field in the downlink control channel.

FIG. 8 illustrates another eNB according to an embodiment of the invention, where the UE includes: a transceiver 510, and at least one processor 500 connected with the transceiver 510, where:

the processor 500 is configured to read and execute program in a memory 520:

to determine the start position of a time unit of a UE, and to determine a division of uplink and downlink regions in the time unit of the UE; to send downlink transmission to the UE through the transceiver 510 in a downlink region in the time unit of the UE; and to receive uplink transmission of the UE through the transceiver 510 in an uplink region corresponding to the downlink region including the downlink transmission; and

the transceiver 510 is configured to receive and transmit data under the control of the processor 500.

Here, in FIG. 8, the bus architecture can include any number of interconnecting buses and bridges to particularly link together various circuits including one or more processors represented by the processor 500, and one or more memories represented by the memory 520. The bus architecture can further link together various other circuits, e.g., a peripheral device, a manostat, a power management circuit, etc., all of which are well known in the art, so a further description thereof will be omitted in this context. The bus interface serves as an interface. The transceiver 510 can be an element, or can be a number of elements, e.g., a number of transmitters and receivers, which are units for communication with various other devices over a transmission medium. The processor 500 is responsible for managing the bus architecture and performing normal processes, and can further provide various functions of timing, a peripheral interface, voltage regulation, power source management, and other control functions, and the memory 520 can store data for use by the processor 500 in performing the operations.

Optionally, the processor 500 can be a CPU, an ASIC, an FPGA, or a CPLD.

Optionally, the processor 500 is configured to read and execute the program in the memory 520:

to notify the UE of the start position via first configuration signaling, where:

the first configuration signaling carries a time offset of the time unit of the UE relative to a preset reference time unit; or

the first configuration signaling carries information about the start position of the time unit of the UE.

Optionally, UEs at the edges of cells are configured with a fixed start position of time unit via the first configuration signaling, and the fixed start position of time unit is a predefined or prescribed start position; or

UEs at the centers of cells are configured with the same or different start positions of time units via the first configuration signaling.

Optionally, the processor 500 is further configured to read and execute the program in the memory 520:

to notify the UE of the division of uplink and downlink regions in the time unit of the UE via second configuration signaling, where:

the second configuration signaling carries information about the length and the position of at least one of an uplink region, a downlink region, and a GP region in the time unit; or

the second configuration signaling carries information representing an division pattern of an uplink region and/or a downlink region in the time unit, where the division pattern of an uplink region and/or a downlink region in the time unit is one of a plurality of preset division patterns of an uplink region and/or a downlink region in a time unit; or

the second configuration signaling carries information about the start position or the end position of a downlink region in the time unit of the UE; or

the second configuration signaling carries information about the start position or the end position of an uplink region in the time unit of the UE.

Optionally, the processor 500 is configured to read and execute the program in the memory 520:

to determine a downlink region in a time unit of the UE as a GP region or a downlink region in a time unit of another UE; and/or

to determine an uplink region in a time unit of the UE as a GP region or an uplink region in a time unit of another UE.

Optionally the processor 500 is configured to read and execute the program in the memory 520:

if the downlink transmission is a downlink control channel with a downlink DCI format, indicating a downlink SPS resource release, to receive ACK/NACK feedback for the downlink control channel through the transceiver 510 in an uplink region corresponding to a downlink region including the downlink control channel; or

if the downlink transmission is a downlink shared channel, to receive ACK/NACK feedback for the downlink shared channel through the transceiver 510 in an uplink region corresponding to a downlink region including the downlink shared channel; or

if the downlink transmission is a downlink control channel with an uplink DCI format, to receive an uplink shared channel corresponding to the downlink control channel through the transceiver 510 in an uplink region corresponding to a downlink region including the downlink control channel.

Here, if the downlink transmission is a downlink control channel with a downlink DCI format, indicating a downlink SPS resource release, then the uplink region corresponding to the downlink region including the downlink transmission will be: a predefined or pre-configured uplink region in the same time unit as the downlink region including the downlink control channel; or an uplink region indicated in an indicating field in the downlink control channel; or an uplink region spaced from the end of the downlink region including the downlink control channel by a preset length of time after the end of the downlink region;

or

if the downlink transmission is a downlink shared channel, then the uplink region corresponding to the downlink region including the downlink transmission will be: a predefined or pre-configured uplink region in the same time unit as the downlink region including the downlink shared channel; or an uplink region indicated in an indicating field in scheduling signaling of the downlink shared channel; or an uplink region spaced from the end of the downlink region including the downlink shared channel by a preset length of time after the end of the downlink region;

or

if the downlink transmission is a downlink control channel with an uplink DCI format, then the uplink region corresponding to the downlink region including the downlink transmission will be: a predefined or pre-configured uplink region in the same time unit as the downlink region including the downlink control channel; or a predefined or pre-configured uplink region in a time unit after the time unit including the downlink region including the downlink control channel; or an uplink region indicated in an indicating field in the downlink control channel.

In the embodiments of the invention, the eNB configures each UE with a time unit specific to the UE so that each UE transmits in the time unit specific to the UE, there may be different start positions of the time units of the different UEs, and there may be also different numbers and lengths of uplink regions and/or downlink regions in the time units of the different UEs, so that a flexible and varying division of resources can be supported.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for transmitting data, the method comprising:
determining, by a UE, a start position of a time unit of the UE, and determining a division of uplink and downlink regions in the time unit;
detecting, by the UE, a downlink control channel in the downlink region of the time unit; and
performing, by the UE, a uplink transmission in an uplink region corresponding to the downlink region according to a detection result.

2. The method according to claim 1, wherein determining, by the UE, the start position of the time unit of the UE comprises:
receiving, by the UE, a first configuration signaling, and determining the start position of the time unit according to the first configuration signaling, wherein:
the first configuration signaling carries a time offset of the time unit relative to a preset reference time unit; or the first configuration signaling carries information about the start position of the time unit.

3. The method according to claim 1, wherein determining, by the UE, the division of uplink and downlink regions in the time unit comprises:
receiving, by the UE, a second configuration signaling, and determining the division of uplink and downlink regions in the time unit according to the second configuration signaling; or
determining, by the UE, an uplink region in the time unit according to a uplink scheduling signaling; or
determining, by the UE, an uplink region carrying Acknowledgement (ACK)/Negative Acknowledgement (NACK) for a downlink transmission according to a feedback position of the ACK/NACK;
wherein the second configuration signaling carries information about a length and position of at least one of an uplink region, a downlink region, and a GP region in the time unit; or
the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or
the second configuration signaling carries information about a start position or an end position of one or more downlink regions in the time unit; or
the second configuration signaling carries information about a start position or an end position of one or more uplink regions in the time unit.

4. The method according to claim 1, wherein performing, by the UE, the uplink transmission in the uplink region corresponding to the downlink region according to the detection result comprises:
if a downlink control channel with an uplink Downlink Control Information (DCI) format is detected, then transmitting, by the UE, an uplink shared channel in an uplink region corresponding to a downlink region comprising the downlink control channel; or
if a downlink control channel with a downlink DCI format, indicating a downlink Semi-Persistent Scheduling (SPS) resource release is detected, then feeding back, by the UE, ACK/NACK in an uplink region corresponding to a downlink region comprising the downlink control channel; or
if a downlink shared channel is detected, then feeding back, by the UE, ACK/NACK in an uplink region corresponding to a downlink region comprising the downlink shared channel.

5. The method according to claim 4, wherein if a downlink control channel with a downlink DCI format indicating a downlink SPS resource release is detected, the uplink region corresponding to the downlink region is: a predefined or pre-configured uplink region in a same time unit as the downlink region comprising the downlink control channel; or an uplink region determined according to an indicating field in the downlink control channel; or an uplink region spaced from an end of the downlink region comprising the downlink control channel by a preset length of time after the end of the downlink region;
or
if a downlink shared channel is detected, the uplink region corresponding to the downlink region is: a predefined or pre-configured uplink region in a same time unit as the downlink region comprising the downlink shared channel; or an uplink region determined according to an indicating field in scheduling signaling of the downlink shared channel; or an uplink region spaced from an end of the downlink region comprising the downlink shared channel by a preset length of time after the end of the downlink region;
or
if a downlink control channel with an uplink DCI format is detected, the uplink region corresponding to the downlink region is: a predefined or pre-configured uplink region in a same time unit as the downlink region comprising the downlink control channel; or a predefined or pre-configured uplink region in a time unit after the time unit comprising the downlink region; or
an uplink region determined according to an indicating field in the downlink control channel.

6. The method according to claim 1, further comprises at least one of following:
the time unit is one or more slots; or
the time unit is one or more subframes;
quantities of downlink regions in time units for transmitting different services are same or different;
quantities of uplink regions in time units for transmitting different services are same or different;
if the time unit comprises at least two downlink regions, lengths of respective downlink regions are same or different;
if the time unit comprises at least two uplink regions, lengths of respective uplink regions are same or different.

7-8. (canceled)

9. A method for transmitting data, the method comprising:
determining, by an eNB, a start position of a time unit of a UE, and determining a division of uplink and downlink regions in the time unit of the UE;
sending, by the eNB, a downlink transmission to the UE in a downlink region in the time unit of the UE; and
receiving, by the eNB, a uplink transmission of the UE in an uplink region corresponding to the downlink region comprising the downlink transmission.

10. The method according to claim 9, wherein after the eNB determines the start position of the time unit of the UE, the method further comprises:
notifying, by the eNB, the UE of the start position via a first configuration signaling, wherein:
the first configuration signaling carries a time offset of the time unit of the UE relative to a preset reference time unit; or
the first configuration signaling carries information about the start position of the time unit of the UE.

11. The method according to claim 9, wherein configuring, by the eNB, UEs at edges of cells with a fixed start position of time unit via the first configuration signaling, and the fixed start position of time unit is a predefined or prescribed start position; or
configuring, by the eNB, UEs at centers of cells with same or different start positions of time units via the first configuration signaling.

12. The method according to claim 9, wherein after the eNB determines the division of uplink and downlink regions in the time unit of the UE, the method further comprises:
notifying, by the eNB, the UE of the division of uplink and downlink regions in the time unit of the UE via second configuration signaling, wherein:
the second configuration signaling carries information about a length and position of at least one of an uplink region, a downlink region, and a GP region in the time unit; or
the second configuration signaling carries information representing an division pattern of an uplink region and/or a downlink region in the time unit, wherein the division pattern of an uplink region and/or a downlink region in the time unit is one of a plurality of preset division patterns of an uplink region and/or a downlink region in a time unit; or
the second configuration signaling carries information about a start position or end position of one or more downlink regions in the time unit of the UE; or
the second configuration signaling carries information about a start position or end position of one or more uplink regions in the time unit of the UE.

13. The method according to claim 9, wherein determining, by the eNB, the start position of the time unit of the UE, and determining the division of uplink and downlink regions in the time unit of the UE comprises:
determining, by the eNB, a downlink region in a time unit of the UE as a GP region or a downlink region in a time unit of another UE; and/or
determining, by the eNB, an uplink region in a time unit of the UE as a GP region or an uplink region in a time unit of another UE.

14. The method according to claim 9, wherein receiving, by the eNB, the uplink transmission of the UE in the uplink region corresponding to the downlink region comprising the downlink transmission comprises:
if the downlink transmission is a downlink control channel with a downlink DCI format, indicating a downlink SPS resource release, receiving, by the eNB, ACK/NACK feedback for the downlink control channel in an uplink region corresponding to a downlink region comprising the downlink control channel; or
if the downlink transmission is a downlink shared channel, receiving, by the eNB, ACK/NACK feedback for the downlink shared channel in an uplink region corresponding to a downlink region comprising the downlink shared channel; or
if the downlink transmission is a downlink control channel with an uplink DCI format, receiving, by the eNB, an uplink shared channel corresponding to the downlink control channel in an uplink region corresponding to a downlink region comprising the downlink control channel.

15. The method according to claim 14, wherein if a downlink control channel with a downlink DCI format indicating a downlink SPS resource release is detected, the uplink region corresponding to the downlink region is: a predefined or pre-configured uplink region in the same time unit as the downlink region comprising the downlink control channel; or an uplink region indicated in an indicating field in the downlink control channel; or an uplink region spaced from the end of the downlink region comprising the downlink control channel by a preset length of time after the end of the downlink region;
or
if a downlink shared channel is detected, the uplink region corresponding to the downlink region will be: a predefined or pre-configured uplink region in the same time unit as the downlink region comprising the downlink shared channel; or an uplink region indicated in an indicating field in scheduling signaling of the downlink shared channel; or an uplink region spaced from the end of the downlink region comprising the downlink shared channel by a preset length of time after the end of the downlink region;
or
if a downlink control channel with an uplink DCI format is detected, the uplink region corresponding to the downlink region will be: a predefined or pre-configured uplink region in the same time unit as the downlink region comprising the downlink control channel; or a predefined or pre-configured uplink region in a time unit after the time unit comprising the downlink region comprising the downlink control channel; or an uplink region indicated in an indicating field in the downlink control channel.

16. The method according to claim 10, further comprises at least one of following:
the time unit is one or more slots; or
the time unit is one or more subframes;
quantities of downlink regions in time units for transmitting different services are same or different;
quantities of uplink regions in time units for transmitting different services are same or different;
if the time unit comprises at least two downlink regions, then the lengths of the respective downlink regions will be the same or different;
if the time unit comprises at least two uplink regions, then the lengths of the respective uplink regions will be the same or different.

17-30. (canceled)

31. A UE, comprising: a transceiver, and at least one processor connected with the transceiver, wherein:
the processor is configured to read and execute a program in a memory:
to determine a start position of a time unit of the UE, and to determine a division of uplink and downlink regions in the time unit; to detect a downlink control channel with the downlink region of the time unit; and to perform a uplink transmission in an uplink region corresponding to the downlink region through the transceiver according to a detection result; and
the transceiver is configured to receive and transmit data under a control of the processor.

32. The UE according to claim 31, wherein the processor is configured to read and execute the program to perform at least one of following operations:
operation 1:
receiving first configuration signaling through the transceiver, and determining the start position of the time unit according to the first configuration signaling, wherein:
the first configuration signaling carries a time offset of the time unit relative to a preset reference time unit; or the first configuration signaling carries information about the start position of the time unit;
operation 2:
receiving a second configuration signaling through the transceiver, and determining the division of uplink and downlink regions in the time unit according to the second configuration signaling; or
determining an uplink region in the time unit according to a uplink scheduling signaling; or
determining an uplink region carrying ACK/NACK for a downlink transmission according to a feedback position of the ACK/NACK;
wherein the second configuration signaling carries information about a length and a position of at least one of an uplink region, a downlink region, and a GP region in the time unit; or
the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or
the second configuration signaling carries information about a start position or an end position of one or more downlink regions in the time unit; or
the second configuration signaling carries information about a start position or an end position of one or more uplink regions in the time unit.

33. (canceled)

34. The UE according to claim 31, wherein the processor is configured to read and execute the program:
if a downlink control channel with an uplink DCI format is detected, to transmit an uplink shared channel in an uplink region corresponding to a downlink region comprising the downlink control channel through the transceiver; or
if a downlink control channel with a downlink DCI format, to indicate a downlink SPS resource release is detected, to feed back ACK/NACK in an uplink region corresponding to a downlink region comprising the downlink control channel through the transceiver; or
if a downlink shared channel is detected, to feed back ACK/NACK in an uplink region corresponding to a downlink region comprising the downlink shared channel through the transceiver.

35. The UE according to claim 34, wherein if a downlink control channel with a downlink DCI format indicating a downlink SPS resource release is detected, the uplink region corresponding to the downlink region is: a predefined or pre-configured uplink region in the same time unit as the downlink region comprising the downlink control channel; or an uplink region determined according to an indicating field in the downlink control channel; or an uplink region spaced from the end of the downlink region comprising the downlink control channel by a preset length of time after the end of the downlink region;
or
if a downlink shared channel is detected, the uplink region corresponding to the downlink region is: a predefined or pre-configured uplink region in the same time unit as the downlink region comprising the downlink shared channel; or an uplink region determined according to an indicating field in scheduling signaling of the downlink shared channel; or an uplink region spaced from the end of the downlink region comprising the downlink shared channel by a preset length of time after the end of the downlink region;
or
if a downlink control channel with an uplink DCI format is detected, the uplink region corresponding to the downlink region is: a predefined or pre-configured uplink region in the same time unit as the downlink region comprising the downlink control channel; or a predefined or pre-configured uplink region in a time unit after the time unit comprising the downlink region comprising the downlink control channel; or an uplink region determined according to an indicating field in the downlink control channel.

36. An eNB, comprising: a transceiver, and at least one processor connected with the transceiver, wherein:
the processor is configured to read and execute a program in a memory:
to determine a start position of a time unit of a UE, and to determine a division of uplink and downlink regions in the time unit of the UE; to send a downlink transmission to the UE through the transceiver in a downlink region in the time unit of the UE; and to receive a uplink transmission of the UE through the transceiver in an uplink region corresponding to the downlink region comprising the downlink transmission; and
the transceiver is configured to receive and transmit data under a control of the processor.

37. The eNB according to claim 36, wherein the processor is configured to read and execute the program at least one of following operations:
operation 1:
notifying the UE of the start position via a first configuration signaling, wherein:
the first configuration signaling carries a time offset of the time unit of the UE relative to a preset reference time unit; or
the first configuration signaling carries information about the start position of the time unit of the UE;
operation 2:
configuring UEs at edges of cells with a fixed start position of time unit via the first configuration signaling, and the fixed start position of time unit is a predefined or prescribed start position; or
configuring UEs at centers of cells with the same or different start positions of time units via the first configuration signaling;
operation 3:
notifying the UE of the division of uplink and downlink regions in the time unit of the UE via second configuration signaling, wherein:
the second configuration signaling carries information about a length and a position of at least one of an uplink region, a downlink region, and a GP region in the time unit; or
the second configuration signaling carries information representing a division pattern of an uplink region and/or a downlink region in the time unit, wherein the division pattern of an uplink region and/or a downlink region in the time unit is one of a plurality of preset division patterns of an uplink region and/or a downlink region in a time unit; or
the second configuration signaling carries information about a start position or an end position of one or more downlink regions in the time unit of the UE; or
the second configuration signaling carries information about a start position or an end position of one or more uplink regions in the time unit of the UE.

38-39. (canceled)

40. The eNB according to claim 36, wherein the processor is configured to read and execute the program:
to determine a downlink region in a time unit of the UE as a GP region or a downlink region in a time unit of another UE; and/or
to determine an uplink region in a time unit of the UE as a GP region or an uplink region in a time unit of another UE.

41. The eNB according to claim 36, wherein if the downlink transmission is a downlink control channel with a downlink DCI format, indicating a downlink SPS resource release, to receive ACK/NACK feedback for the downlink control channel through the transceiver in an uplink region corresponding to a downlink region comprising the downlink control channel; or
if the downlink transmission is a downlink shared channel, to receive ACK/NACK feedback for the downlink shared channel through the transceiver in an uplink region corresponding to a downlink region comprising the downlink shared channel; or
if the downlink transmission is a downlink control channel with an uplink DCI format, to receive an uplink shared channel corresponding to the downlink control channel through the transceiver in an uplink region corresponding to a downlink region comprising the downlink control channel.

42. The eNB according to claim 41, wherein if a downlink control channel with a downlink DCI format indicating a downlink SPS resource release is detected, the uplink region corresponding to the downlink region is: a predefined or pre-configured uplink region in the same time unit as the downlink region comprising the downlink control channel; or an uplink region indicated in an indicating field in the downlink control channel; or an uplink region spaced from the end of the downlink region comprising the downlink control channel by a preset length of time after the end of the downlink region;
or
if a downlink shared channel is detected, the uplink region corresponding to the downlink region is: a predefined or pre-configured uplink region in the same time unit as the downlink region comprising the downlink shared channel; or an uplink region indicated in an indicating field in scheduling signaling of the downlink shared channel; or an uplink region spaced from the end of the downlink region comprising the downlink shared channel by a preset length of time after the end of the downlink region;
or
if a downlink control channel with an uplink DCI format is detected, the uplink region corresponding to the downlink region is: a predefined or pre-configured uplink region in the same time unit as the downlink region comprising the downlink control channel; or a predefined or pre-configured uplink region in a time unit after the time unit comprising the downlink region comprising the downlink control channel; or an uplink region indicated in an indicating field in the downlink control channel.
